(19) United States
(12) Patent Application Publication
(10) Pub. No.: US 2010/0060566 A1
(43) Pub. Date: Mar. 11, 2010

(54) ELECTRONIC BOOK READING APPARATUS AND UPDATING METHOD THEREOF

(75) Inventors: HAN-CHE WANG, Tu-Cheng (TW); CHUN-WEI PAN, Tu-Cheng (TW); BIN-GANG DUAN, Shenzhen City (CN); ZONG-HUI DONG, Shenzhen City (CN); KUAN-HONG HSIEH, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) Co.,LTD., ShenZhen City (TW); HON HAI PRECISION INDUSTRY CO., LTD., Tu-Cheng (TW)

(21) Appl. No.: 12/346,863

(22) Filed: Dec. 31, 2008

(30) Foreign Application Priority Data
Sep. 11, 2008 (CN) 200810304460.8

(51) Int. Cl. G09G 3/34

(52) U.S. Cl. 345/107

(57) ABSTRACT

A method of updating content applied on an E-book, which includes: an electronic paper display, a first power supply, a RTC, a second power supply, a power manager, and a central processor. The method includes: keep time; generating a control signal for turning on the first power supply when it is time to update; turning on the first power supply in response to the control signal; updating content displayed on the electronic paper display; and cutting off the first power supply after updating is completed.

### TECHNICAL FIELD

The disclosure relates to an electronic book reading apparatus (E-book) capable of updating displayed content and method of updating for the apparatus.

### DESCRIPTION OF RELATED ART

Electronic books and publications have developed and grown in popularity. As opposed to books in paper form, electronic books are read on an electronic book reading apparatus that displays readable content as it would appear in a non-electronic book, thereby reducing costs of printing, binding, warehousing, and distributing.

A typical electrical book reading apparatus (E-book) is configured with an electronic paper display. When the E-book is in a sleep mode in which the E-book can save electrical power, content on the display can be maintained but not updated. The E-book may include additional functions besides displaying book content, such as current time, date, weather etc, but this kind of content is not useful to the user during sleep mode since it is not updated.

Therefore, what is needed is an E-book capable of automatically updating displayed content even in a sleep mode and method thereof.

### BRIEF DESCRIPTION OF THE DRAWINGS

The components of the drawings are not necessarily drawn to scale, the emphasis instead being placed upon clearly illustrating the principles of an electronic book reading apparatus. Moreover, in the drawings, like reference numerals designate corresponding parts throughout several views.

FIG. 1 is a block diagram of an electronic book reading apparatus (E-book) in accordance with an exemplary embodiment.

FIG. 2 is a flowchart for a method of updating displayed content of the E-book of FIG. 1 in accordance with an exemplary embodiment.

### DETAILED DESCRIPTION OF EMBODIMENTS

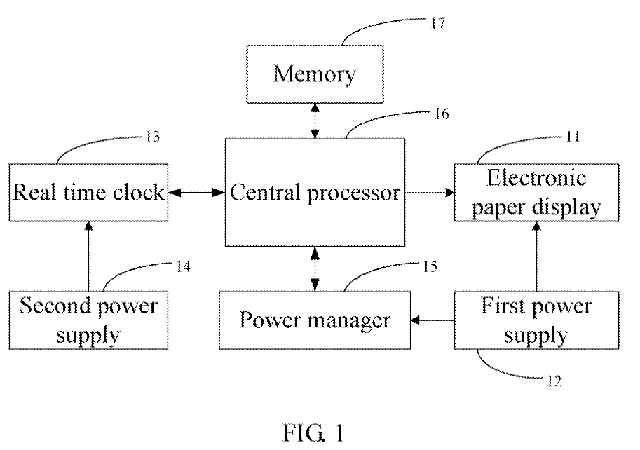

FIG. 1 is an exemplary block diagram of a hardware infrastructure of an E-book in accordance with an exemplary embodiment. The E-book includes at least one electronic paper display 11, a first power supply 12, a real-time clock (RTC) 13, a second power supply 14, a power manager 15, a central processor 16, and a memory 17.

The electronic paper display 11 is in a form of electronic paper and is configured for displaying content. In the exemplary embodiment, the content includes, but is not limited to, news, weather, road traffic, stock quotes, and the like. When the first power supply 12 is cut off, the electronic paper display 11 maintains content on display.

The first power supply 12 is configured for supplying power for the electronic paper display 11.

The RTC 13 is configured for keeping time, and generating a control signal at predetermined intervals during sleep mode. The control signal is configured for starting the first power supply 12. The predetermined intervals can be a default parameter of the RTC 13, or can be defined by a user manually when the E-book is turned on. In an exemplary embodiment, for example, an interval is 1.0 second, therefore, the RTC 13 generates the control signal every second. The RTC 13 is further configured for sending the control signal to the central processor 16.

The second power supply 14 is configured for supplying power to the RTC 13 when the E-book is in a sleep mode, to maintain power to the RTC 13.

The power manager 15 is configured for controlling the first power supply 12.

The central processor 16 is connected to the RTC 13 and the power manager 15. The central processor 16 is configured for controlling the power manager 15 to turn on the first power supply 12 when it receives the control signal from the RTC 13, and updating content displayed on the electronic paper display 11 after turning on the first power supply 12. The central processor 16 is further configured for controlling the power manager 15 to cut off the first power supply 12 after updating has completed.

Furthermore, when it is time to update, the central processor 16 controls the power manager 15 to turn on the first power supply 12, and only runs those system functions needed to accomplish the updating of the content on the electronic paper display 11.

The memory 17 is configured for storing a predetermined content display setting. In an exemplary embodiment, the predetermined content display setting includes, but is not limited to, date/time, news, weather, road traffic, stock quotes. In the exemplary embodiment, when it is time to update, the central processor 16 controls the power manager 15 to turn on the first power supply 12, retrieves the predetermined content display setting from the memory 17 and displays the updated content, according to the predetermined content display setting, on the electronic paper display 11.

For the purpose of easy understanding, an exemplary updating process is described as follows. Suppose that the E-book is in sleep mode, the predetermined updating interval is one second, and the content displayed on the electronic paper display 11 is the date/time information, e.g., 3:30 PM, Jul. 24, 2008. The RTC 13 keeps time, and generates the control signal for turning on the first power supply 12 after one second. The central processor 16 controls the power manager 15 to turn on the first power supply 12 in response to the control signal, and content displayed is not up to date, then it updates the date/time on the electronic paper display 11. That is, the central processor 16 changes 3:30 PM, Jul. 24, 2008 to 3:31 PM, Jul. 24, 2008 on the electronic paper display 11, which is now the current time. After updating the data/time information on the electronic paper display 11, the central processor 16 controls the power manager 15 to cut off the first power supply 12, and the E-book is put back in sleep mode again.

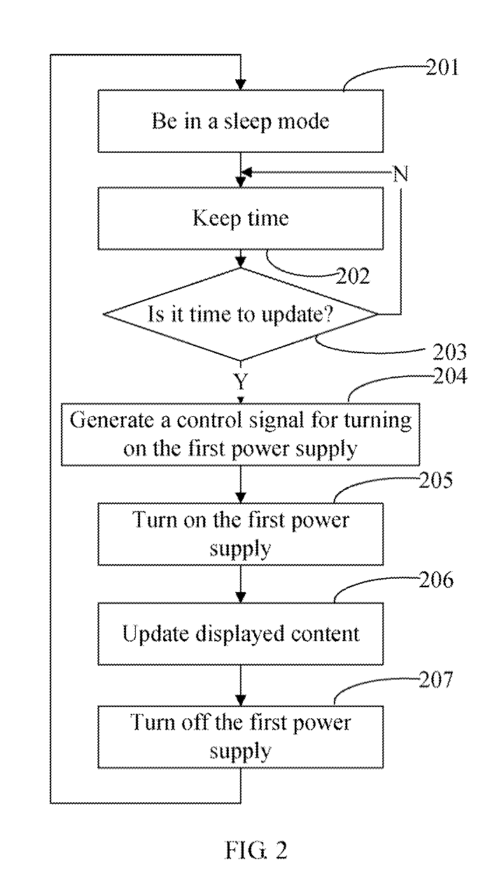

FIG. 2 is a flowchart for a method of updating displayed content on the E-book of FIG. 1 in accordance with an exemplary embodiment.

In step S201, the E-book is in the sleep mode, that is, the first power supply 12 is cut off.

In step S202, the RTC 13 is keeping time, and the second power supply 14 is supplying electrical power for the RTC 13, and the first power supply 12 is cut off.

In step S203, the RTC 13 determines if the predetermined updating interval has passed. If no, it will not wake up the E-book; if yes, the procedure goes to step S204 described below.

In step S204, the RTC 13 sends the control signal for turning on the first power supply 12 to the central processor 16.

In step S205, the central processor 16 controls the power manager 15 to turn on the first power supply 12 in response to the received control signal.

In step S206, the central processor 16 updates content displayed on the electronic paper display 11 accordingly. Furthermore, in order to save more power, the central processor 16 runs only those system functions required to accomplish updating content displayed on the electronic paper display 11.

In step S207, after updating, the central processor 16 controls the power manager 15 to cut off the first power supply 12, and the procedure returns to step S201, and the E-book is in the sleep mode again.

Although the present invention has been specifically described on the basis of the exemplary embodiment thereof, the invention is not to be construed as being limited thereto. Various changes or modifications may be made to the embodiment without departing from the scope and spirit of the invention.

What is claimed is:

1. An electronic book reading apparatus (E-book), comprising:
an electronic paper display;
a first power supply for supplying electrical power to the display;
a real-time clock (RTC) configured for keeping time and generating a control signal for turning on the first power supply at predetermined intervals during sleep mode;
an second power supply, connected with the RTC, for supplying power to the RTC when the first power supply is cut off;
a power manager, for managing the second power supply;
a central processor, connected with the RTC and the power manager, configured for controlling the power manager to turn on the first power supply in response to the control signal from the RTC, and updating content displayed on the electronic paper display; the central processor being further configured for controlling the power manager to cut off the first power supply after updating is completed.

2. The E-book as described in claim 1, wherein the predetermined interval is a default parameter of the RTC, and is able to be defined by a user manually when the E-book is turned on.

3. The E-book as described in claim 1, wherein the central processor runs those system functions needed to accomplish the updating of the content on the electronic paper display.

4. The E-book as described in claim 1, further comprising a memory, wherein the memory stores a predetermined content display setting, wherein the predetermined content display setting includes at least one of information of news, weather, road traffic, or stock quotes.

5. The E-book as described in claim 4, wherein when the RTC determines that it is time to update, the central processor controls the power manager to turn on the first power supply and displays the predetermined content display setting on the electronic paper display.

6. The E-book as described in claim 5, wherein the central processor retrieves the predetermined content display setting from the memory and displays it on the electronic paper display.

7. A method of updating displayed content on an electronic book reading apparatus (E-book), wherein the E-book comprises:
an electronic paper display;
a first power supply; and
a real-time clock (RTC);
the method comprising:
generating a control signal by the RTC for turning on the first power supply when it is time to update;
turning on the first power supply in response to the control signal;
updating content displayed on the electronic paper display; and
turning off the first power supply after updating is completed.

8. The method as described in claim 7, further comprising: running only those system functions required to accomplish updating content displayed on the electronic paper display.

9. The method as described in claim 7, further comprising: retrieving a predetermined content display setting, wherein the predetermined content display setting includes at least one of information of news, weather, road traffic, or stock quotes.
